(19) United States
(12) Patent Application Publication
(10) Pub. No.: US 2025/0077678 A1
(43) Pub. Date: Mar. 6, 2025

(54) PROTECTING RISK ENTRIES USING DISINFORMATION ENTRIES

(71) Applicant: Meta Platforms, Inc., Menlo Park, CA (US)

(72) Inventor: Brandon Sloane, Lancaster, SC (US)

(21) Appl. No.: 17/894,486

(22) Filed: Aug. 24, 2022

(51) Int. Cl. G06F 21/57; G06F 21/62; G06F 21/64

(52) U.S. Cl. CPC G06F 21/577; G06F 21/6218; G06F 21/64; G06F 2221/034

(57) ABSTRACT

A method of protecting a risk threat is disclosed. A new entry to be stored in a database store is received, wherein the new entry identifies a risk threat. A plurality of disinformation entries is generated based on the new entry to be stored in the database store. Security signatures for the new entry and the plurality of disinformation entries are determined. An authorized user is allowed to use the security signatures to identify the new entry in the database store as a legitimate entry.

### BACKGROUND OF THE INVENTION

Data risk is the exposure to loss of value or reputation caused by issues or limitations to an organization's ability to acquire, store, transmit, transform, move, and use its data assets. There are internal and external data risks. Internal risks include risks introduced by the employees of a company or members of an organization. External risks include attacks by external hackers and cybercriminals. Improved techniques for reducing the data risks of companies or organizations would be desirable.

### BRIEF DESCRIPTION OF THE DRAWINGS

Various embodiments of the invention are disclosed in the following detailed description and the accompanying drawings.

FIG. 1 illustrates an exemplary data risk management process 100.

FIG. 2 illustrates an exemplary process 200 for storing, managing, and protecting data risk information.

FIG. 3 illustrates an exemplary system 300 for storing, managing, and protecting data risk information.

FIG. 4 illustrates an exemplary process 400 for generating a plurality of disinformation entries based on the new entry that identifies the risk threat.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Data risk is the potential of failures in the storage, use, transmission, management, and security of data. There are many types of data risks. A data breach is a security violation in which sensitive, protected, or confidential data is copied, transmitted, viewed, stolen, or used by an entity unauthorized to do so. The compromised data may include company trade secrets, contacts, financial credentials, financial data, authentication credentials, personal or business communications, medical data, personal data, employee records, proprietary designs, and the like. Another type of data risk is caused by insecure applications. A company may use different applications that store and transmit sensitive data, significantly increasing the ways hackers may obtain the company's data. For example, a company may use cloud-based applications, and these applications can expose the company to risk if the applications experience a breach. Another type of data risk is unauthorized third-party access.

Tasks that are performed on risk related items should be assigned in a secure manner such that a malicious attacker cannot easily detect those tasks or the risk related items associated with those tasks. In some traditional techniques, a closed system may be used, which requires users working on the tasks to sign into a system. An enterprise may use a system that is integrated with a general task management software without any masking or obfuscation mechanisms, which may allow a malicious attacker to find out the risks and problems of the system and how the enterprise is handling those risks and problems.

Information related to the data risks of a company or organization may be stored in a data risk register. Typically, an access-control list (ACL) may be used to control the access to a data risk register. An ACL is a list of permissions associated with the information stored in the data risk register. An ACL specifies which users or system processes are granted access to the objects stored in the data risk register, as well as what operations are allowed on the objects. Each entry in a typical ACL specifies a subject and an operation. For instance, only a limited group of entities or people may be given the permission to read and write, another limited group of entities or people may be given the permission to read only, while others are denied any kind of access.

However, using access-control lists to control access to the data risk register has a number of disadvantages. For example, it is often difficult to determine what entities can access certain types of data risk information. It is also difficult to revoke all access right to certain data risk information. The administrators of the data risk register may also make mistakes in setting the permissions, thereby exposing the data risk information to unauthorized users. Therefore, improved techniques for protecting data risk information would be desirable.

In the present application, a method of protecting a risk threat is disclosed. A new entry to be stored in a database store is received, wherein the new entry identifies a risk threat. A plurality of disinformation entries is generated based on the new entry to be stored in the database store. Security signatures for the new entry and the plurality of disinformation entries are determined. An authorized user is allowed to use the security signatures to identify the new entry in the database store as a legitimate entry.

A system for protecting a risk threat is disclosed. The system comprises a processor. The processor is configured to receive a new entry to be stored in a database store, wherein the new entry identifies a risk threat. The processor is configured to generate a plurality of disinformation entries based on the new entry to be stored in the database store. The processor is configured to determine security signatures for the new entry and the plurality of disinformation entries. The processor is configured to allow an authorized user to use the security signatures to identify the new entry in the database store as a legitimate entry. The system comprises a memory coupled to the processor and configured to provide the processor with instructions.

A computer program product for protecting a risk threat is disclosed. The computer program product is embodied in a non-transitory computer readable medium. The computer program product comprises computer instructions for receiving a new entry to be stored in a database store, wherein the new entry identifies a risk threat. The computer program product comprises computer instructions for generating a plurality of disinformation entries based on the new entry to be stored in the database store. The computer program product comprises computer instructions for determining security signatures for the new entry and the plurality of disinformation entries. The computer program product comprises computer instructions for allowing an authorized user to use the security signatures to identify the new entry in the database store as a legitimate entry.

To protect the risk information from being used by any unauthorized entities or persons, disinformation entries are generated and stored into the data risk register together with the real risk entries that contain real risk information. The disinformation entries include false information which is intended to mislead. The benefit of combining these disinformation entries with the real risk entries includes masking the real risk information with false, confusing, and misleading risk information, thereby obfuscating the real risk information by rendering the real risk information obscure, unclear, or unintelligible. The disinformation entries make it difficult or impossible for any unauthorized entities or persons who can gain access to the data risk register to comprehend and exploit the real risk information.

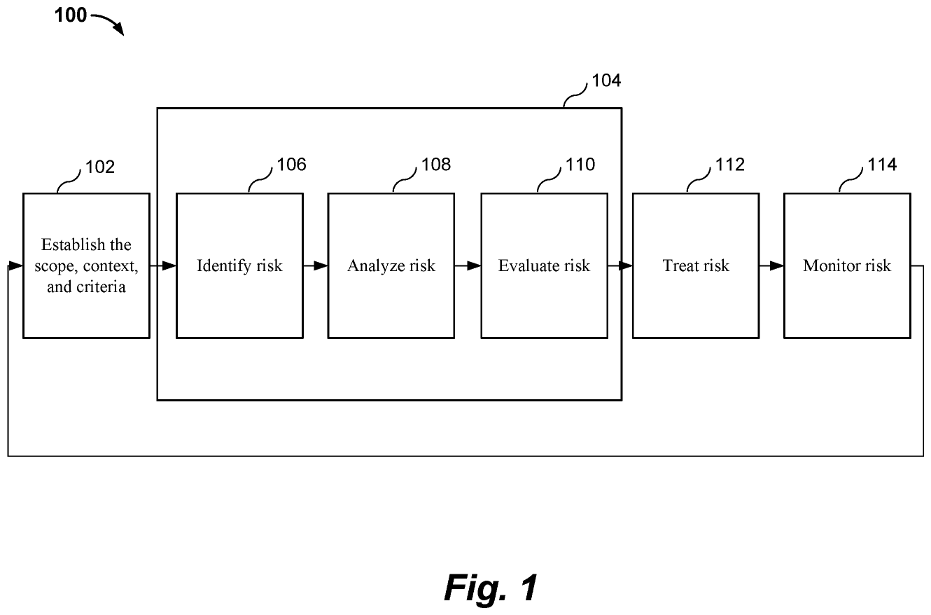

FIG. 1 illustrates an exemplary data risk management process 100. Data risk management process 100 is an ongoing process of identifying, treating, and managing data risks of a company or an organization. Process 100 includes a number of steps.

At step 102, the scope, context, and criteria of the data risk management process are established. The purpose of establishing the scope, context, and criteria is to customize the risk management process, enabling effective risk assessment and appropriate risk treatment.

Next, data risk assessment is performed by a data risk assessment module 104. Data risk assessment includes a number of sub-steps. At step 106, data risks are identified. The purpose of risk identification is to find, recognize, and describe risks that might help or prevent an organization in achieving its objectives. Relevant, appropriate, and up-to-date information is important in identifying risks.

At step 108, data risks are analyzed. The purpose of risk analysis is to comprehend the nature of the data risks and their characteristics, including, where appropriate, the level of the data risks. Data risk analysis involves a detailed consideration of uncertainties, data risk sources, consequences, likelihoods, events, scenarios, controls, and their effectiveness. An event may have multiple causes and consequences and may affect multiple objectives.

At step 110, data risks are evaluated. The purpose of data risk evaluation is to support decisions. Data risk evaluation involves comparing the results of the data risk analysis with the established data risk criteria to determine where additional actions are required.

At step 112, data risks are treated. The purpose of data risk treatment is to select and implement options for addressing the data risks. At step 114, data risks are monitored. The purpose of monitoring and reviewing of the data risks is to assure and improve the quality and effectiveness of the process design, implementation, and outcomes. After step 114, process 100 may proceed back to step 102 and process 100 may repeat again.

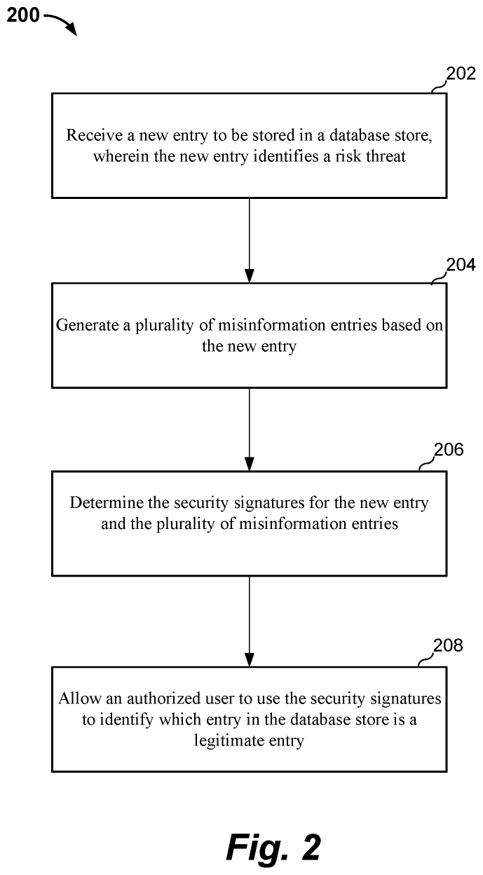

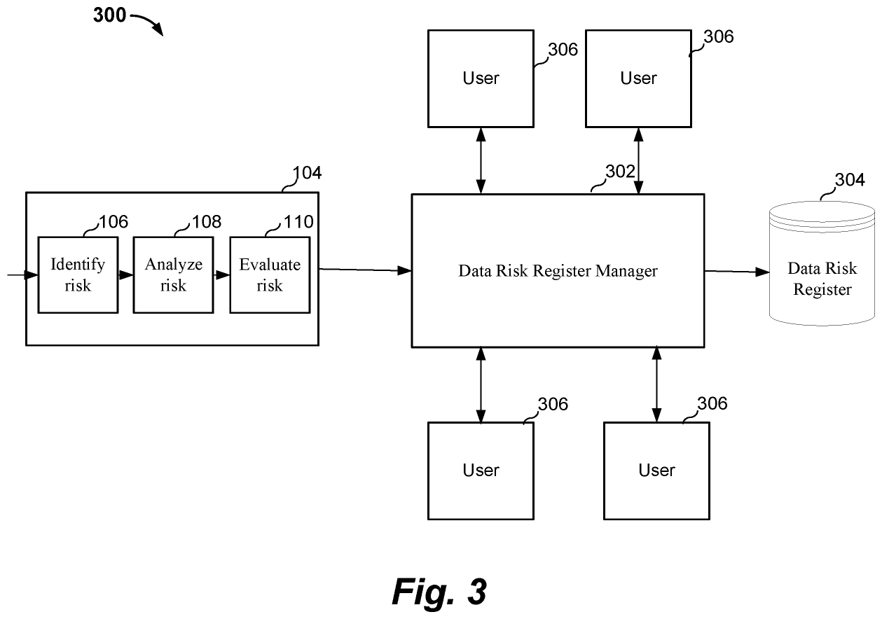

FIG. 2 illustrates an exemplary process 200 for storing, managing, and protecting data risk information. FIG. 3 illustrates an exemplary system 300 for storing, managing, and protecting data risk information. In some embodiments, process 200 may be performed by system 300.

At step 202, a new entry to be stored in a database store is received, wherein the new entry identifies a risk threat. For example, information related to a data risk threat of a company or organization may be received by a data risk register manager 302 to be stored as a new entry in a database store, such as a data risk register 304. The new entry identifies the data risk threat. For example, the data risk threat may be related to the execution of a task assigned to an employee of the company.

In some embodiments, the new entry may be manually entered by a human administrator. In some embodiments, the entering of the new entry is automated, e.g., via a scanning process. In some embodiments, the new entry is received from another module, such as a data risk assessment module. With reference to FIG. 3, the information collected by data risk assessment module 104 may be received by a data risk register manager 302 to be stored in a data risk register 304. Data risk register 304 is a record of information about identified risks. It is a repository for data risks identified by data risk assessment module 104. It may also store additional information about each data risk, e.g., nature of the data risk, reference and owner of the data risk, and mitigation measures for the data risk. The information about each data risk may be the results obtained at any stage or step of data risk assessment module 104. For example, the information may be the final or intermediate results obtained at steps 106, 108, and 110 that are performed by data risk assessment module 104.

The information stored in data risk register 304 may specify the assets, resources, processes, or systems and their associated risks and vulnerabilities. A vulnerability is a flaw or a weakness that may affect security. For example, a file in an operating system library may have a programming vulnerability that allows attackers to get access to the operating system itself. In another example, an online application may have a vulnerability in which the communicated content or login passwords are not protected by encryption. The threat vectors or attack vectors of the risks and vulnerabilities may also be included in the data risk register 304. A threat vector is the path that someone takes to gain access to a device so that they can take advantage of a vulnerability. In addition, the probability and impact of the risks and vulnerabilities may also be included.

At step 204, a plurality of disinformation entries is generated based on the new entry. To protect the risk information from being used by any unauthorized entities or persons, disinformation entries are generated by data risk register manager 302 and stored into data risk register 304 together with the real risk entries that contain real risk information. The disinformation entries are modified or mutated versions of the corresponding real entry with fields or parameters that are false and misleading. For example, for each real risk entry, a large number of disinformation entries identifying fictious data risks that closely resemble the real risk threat identified by the real risk entry may be generated and stored in the data risk register 304. In some embodiments, some of the disinformation entries have different values for a particular field or parameter and each value is modified from the original value of the field in the new entry. For example, the field of each of these disinformation entries is a different permutation.

The benefit of combining these disinformation entries with the real risk entries in data risk register manager 302 includes masking the real risk information with false, confusing, and misleading risk information, thereby obfuscating the real risk information by rendering the real risk information obscure, unclear, or unintelligible. The disinformation entries make it difficult or impossible for any unauthorized entities or persons who can gain access to data risk register 304 to distinguish the real entries from the disinformation entries, thereby preventing the unauthorized entities from comprehending and exploiting the real risk information.

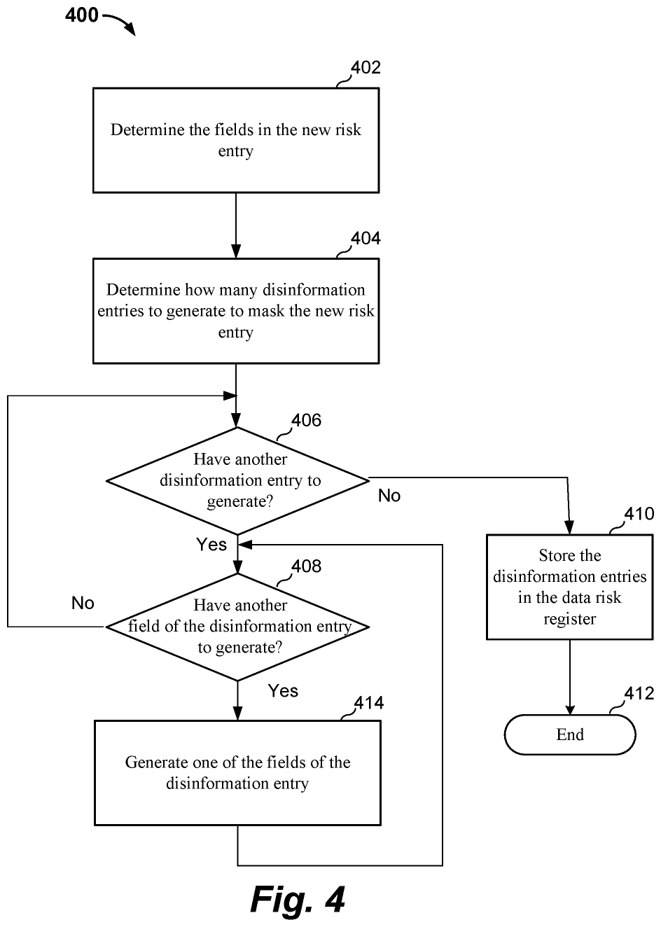

FIG. 4 illustrates an exemplary process 400 for generating a plurality of disinformation entries based on the new entry that identifies the risk threat. In some embodiments, process 400 is performed at step 204 of process 200 by data risk register manager 302.

At step 402, a plurality of fields in the new entry is determined. Each new entry may include different fields, and each field may include different aspects of the particular risk threat associated with the new entry. And each field may be encoded or described using a different format. Therefore, the techniques of generating the plurality of fields may be different from each other, as will be described in greater detail below.

At step 404, the number of disinformation entries to be generated by data risk register manager 302 for masking and obfuscating the new risk entry is determined. Typically, the greater the number of disinformation entries that are generated and stored together with each new risk entry, the higher the level of masking and obfuscation is provided to protect the new risk entry. However, it also requires more computation time and computation power from data risk register manager 302, and more storage space in data risk register 304. Therefore, the number of disinformation entries to be generated by data risk register manager 302 may be determined based on a number of factors.

One type of factor is a measure of riskiness associated with the risk threat, i.e., the degree or level of the risk. In some embodiments, the relative riskiness of the risk threat is one of the factors that is used to determine how many disinformation entries are generated and how they are generated. Riskiness may be measured in terms of the amount of harm it may cause. For example, a relatively benign task may not warrant any obfuscating efforts, whereas an unauthorized task that may cause a significant level of harm may warrant the generation of thousands of disinformation tasks.

Riskiness may be measured in terms of how business-critical the task or application is to a company or an organization. A business-critical application is essential for business continuity. If a business-critical application fails or is interrupted, normal operations of the organization cannot proceed as usual. This can lead to short-term and long-term financial losses, decreased productivity, loss of brand authority, and loss of customer trust. Therefore, a greater number of disinformation entries are generated if the risk is related to a business-critical application instead of a non-critical or low-priority application.

Riskiness may be measured in terms of the level of impact associated with the risk threat. For example, a greater number of disinformation entries are generated if the risk is related to an application that is widely deployed and used by millions of users instead of an application that is used by a small group of users.

Another type of factor is a measure of the likelihood of the real entry being identified among the associated disinformation entries by an unauthorized entity or person. In some embodiments, the relative level of difficulty of identifying the real entry from the disinformation entries is used to determine how many disinformation entries to generate. For example, if it is difficult for an unauthorized person to discern the differences between the disinformation entries from the real entry, then fewer disinformation entries may be needed to mask the presence of the real entry.

At step 406, whether there is another disinformation entry associated with the new risk entry to be generated by data risk register manager 302 is determined. If there is another disinformation entry associated with the new entry to be generated by data risk register manager 302, then process 400 proceeds to step 408; otherwise, process 400 proceeds to step 410. At step 410, the disinformation entries generated by data risk register manager 302 are stored into data risk register 304. Then process 400 proceeds to step 412 and the process is terminated.

At step 408, whether there is another field of the disinformation entry associated with the new entry to be generated by data risk register manager 302 is determined. If there is another field of the disinformation entry associated with the new entry to be generated by data risk register manager 302, then process 400 proceeds to step 414; otherwise, process 400 proceeds to step 406, such that another disinformation entry associated with the risk entry may be generated.

At step 414, one of the fields of the disinformation entry associated with the new risk entry is generated. The field of the disinformation entry is a mutated or modified version of the corresponding field of the new entry. And the field of this disinformation entry may be different from the corresponding field of another disinformation entry. For example, the field of each of the disinformation entries is a different permutation. Each field may be encoded or described using a different format. Therefore, the technique of generating each of the fields may be different. In some embodiments, a mutated or modified field may be generated using multiplicative hashing and a random number generator.

In some embodiments, a field of the new risk entry identifies the owner of the risk. For example, the owner of the risk may be a name, such as the name of a person, a group, or a team. In some embodiments, a list (of size n) of all the entities (e.g., people or teams) which have submitted one or more risk entries to the database is gathered. Each entity is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies a threat vector associated with the risk threat. There are n categories. For example, the entities may be one of the following: an insider, an advanced persistent threat, or a hacktivist. Each entity is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies an asset class associated with the risk threat. There are n categories of asset class. For example, the asset class may be one of the following: data, facility, people, product, or system. Each entity is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies an asset associated with the risk threat. The asset may be an asset listed in an internal inventory. There are n categories. Each entity is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies a likelihood of the risk threat. The field may be numerical values representing the probabilistic curve that describes the likelihood, e.g., an average value, a standard deviation, a low value, or a high value. In some embodiments, a list (of size n) of all the risks (both real and fictitious) that fit within the same category as this new item is gathered. The relevant probabilistic values are extracted from each of those risk entries. Examples of probabilistic values include an average, a standard deviation, a low value, and a high value. For each of those extracted probabilistic values, appropriate ranges of expected values are derived. Each probabilistic value is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies a primary loss associated with the risk threat. The field may be numerical values representing the probabilistic curve that describes the likely financial loss as a result of the risk event, e.g., an average value, a standard deviation, a low value, or a high value. In some embodiments, a list (of size n) of all the risks (both real and fictitious) that fit within the same category as this new item is gathered. The relevant probabilistic values are extracted from each of those risk entries. Examples of probabilistic values include an average, a standard deviation, a low value, and a high value. For each of those extracted probabilistic values, appropriate ranges of expected values are derived. Each probabilistic value is assigned a random number from 1 to n using a multiplicative hash of modular arithmetic with prime numbers and an integer salt value generated at the time of the database instantiation. For each degree of entropy required, a random entity index number is selected using a random number generator.

In some embodiments, a field of the new entry identifies a secondary loss associated with the risk threat. The field may be numerical values representing the probabilistic curve that describes the likely financial loss as a result of the risk event, e.g., an average value, a standard deviation, a low value, or a high value. In some embodiments, a list (of size n) of all the risks (both real and fictitious) that fit within the same category as this new item is gathered. The relevant probabilistic values are extracted from each of those risk entries. Examples of probabilistic values include an average, a standard deviation, a low value, and a high value. For each of those extracted probabilistic values, appropriate ranges of expected values are derived. Each probabilistic value is assigned a random number from 1 to n using a multiplicative hash of modular arithmetic with prime numbers and an integer salt value generated at the time of the database instantiation. For each degree of entropy required, a random entity index number is selected using a random number generator.

After step 414 is finished, process 400 proceeds to step 408, such that another field of the disinformation entry associated with the new risk entry may be generated.

Referring back to FIG. 2, at step 206, security signatures for the new entry and the plurality of disinformation entries are determined. At step 208, an authorized user 306 is allowed to use the security signatures to identify which entry in the database store is a legitimate entry.

In some embodiments, pre-shared keys and hashing algorithms against tagged values are utilized to identify which entry in the database store is a legitimate entry. In some embodiments, a public key infrastructure (PKI) is used to identify which entry in the database store is a legitimate entry. In particular, certificate-based signing may be used to dynamically revoke and modify the signing values, such that the ability of a previously authorized entity to identify legitimate entries in the database is revoked dynamically.

In some embodiments, the entries in the data risk register 304 may be segmented into separate pools, each for a different functional group within the company or organization. For example, data risk register manager 302 may distribute different signing algorithms and certificates to different functional groups, such that each functional group may be able to identify only a subset of the real entries from their associated misinformation entries, while other functional groups cannot filter out the same subset of the real entries. In other words, this subset of real entries and their associated misinformation entries look like noise to another functional group, which further helps to mask the real entries of that functional group.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a new entry to be stored in a database store, wherein the new entry identifies a risk threat;
generating a plurality of disinformation entries based on the new entry to be stored in the database store;
determining security signatures for the new entry and the plurality of disinformation entries; and
allowing an authorized user to use the security signatures to identify the new entry in the database store as a legitimate entry.

2. The method of claim 1, further comprising receiving the new entry to be stored in the database store from a data risk assessment module, and wherein the new entry includes one or more results obtained at one of a plurality of stages of the data risk assessment module, and wherein the plurality of stages of the data risk assessment module includes an identifying risk stage, an analyzing risk stage, and an evaluating risk stage.

3. The method of claim 1, further comprising determining a number of the plurality of disinformation entries based on a measure of riskiness associated with the risk threat of the new entry.

4. The method of claim 1, further comprising determining a number of the plurality of disinformation entries based on a measure of harm associated with the risk threat of the new entry.

5. The method of claim 1, further comprising determining a number of the plurality of disinformation entries based on a level of impact associated with the risk threat of the new entry.

6. The method of claim 1, further comprising determining a number of the plurality of disinformation entries based on a measure of difficulty of identifying the new entry from the plurality of disinformation entries.

7. The method of claim 1, wherein the generating of the plurality of disinformation entries based on the new entry comprises:
generating the plurality of disinformation entries as modified versions of the new entry, wherein a field of one of the plurality of disinformation entries includes false information that is modified from an original field of the new entry.

8. The method of claim 7, further comprising:
generating the field of the one of the plurality of disinformation entries based on multiplicative hashing and a random number generator.

9. The method of claim 7, further comprising:
generating the field of the one of the plurality of disinformation entries based on a probabilistic curve.

10. The method of claim 7, wherein the field of the one of the plurality of disinformation entries identifies one of the following: an owner of the risk threat, a threat vector associated with the risk threat, an asset class associated with the risk threat, an asset associated with the risk threat, a likelihood of the risk threat, a primary loss associated with the risk threat, or a secondary loss associated with the risk threat.

11. The method of claim 1, further comprising:
using certificate-based signing to dynamically revoke the allowing of the authorized user to identify the new entry in the database store as the legitimate entry.

12. The method of claim 1, further comprising:
distributing different signing algorithms and certificates to different functional groups, such that a functional group among the different functional groups is able to identify only a subset of a plurality of legitimate entries stored in the database store.

13. A system, comprising:
a processor configured to:
receive a new entry to be stored in a database store, wherein the new entry identifies a risk threat;
generate a plurality of disinformation entries based on the new entry to be stored in the database store;
determine security signatures for the new entry and the plurality of disinformation entries; and
allow an authorized user to use the security signatures to identify the new entry in the database store as a legitimate entry; and
a memory coupled to the processor and configured to provide the processor with instructions.

14. The system of claim 13, wherein the processor is configured to:
receive the new entry to be stored in the database store from a data risk assessment module, and wherein the new entry includes one or more results obtained at one of a plurality of stages of the data risk assessment module, and wherein the plurality of stages of the data risk assessment module includes an identifying risk stage, an analyzing risk stage, and an evaluating risk stage.

15. The system of claim 13, wherein the processor is configured to:
determine a number of the plurality of disinformation entries based on a measure of riskiness associated with the risk threat of the new entry.

16. The system of claim 13, wherein the processor is configured to:
generate the plurality of disinformation entries as modified versions of the new entry, wherein a field of one of the plurality of disinformation entries includes false information that is modified from an original field of the new entry.

17. A computer program product embodied in a non-transitory computer readable medium and comprising computer instructions for:
receiving a new entry to be stored in a database store, wherein the new entry identifies a risk threat;
generating a plurality of disinformation entries based on the new entry to be stored in the database store;
determining security signatures for the new entry and the plurality of disinformation entries; and
allowing an authorized user to use the security signatures to identify the new entry in the database store as a legitimate entry.

18. The computer program product of claim 17, further comprising computer instructions for:
receiving the new entry to be stored in the database store from a data risk assessment module, and wherein the new entry includes one or more results obtained at one of a plurality of stages of the data risk assessment module, and wherein the plurality of stages of the data risk assessment module includes an identifying risk stage, an analyzing risk stage, and an evaluating risk stage.

19. The computer program product of claim 17, further comprising computer instructions for:
determining a number of the plurality of disinformation entries based on a measure of riskiness associated with the risk threat of the new entry.

20. The computer program product of claim 17, further comprising computer instructions for:
generating the plurality of disinformation entries as modified versions of the new entry, wherein a field of one of the plurality of disinformation entries includes false information that is modified from an original field of the new entry.
